(19) United States
(12) Patent Application Publication
(10) Pub. No.: US 2015/0003821 A1
(43) Pub. Date: Jan. 1, 2015

(54) Camera filter mount and related methods

(71) Applicant: JEFFREY OVERALL, Fountain Valley, CA (US)

(72) Inventor: JEFFREY OVERALL, Fountain Valley, CA (US)

(21) Appl. No.: 13/998,655

(22) Filed: Nov. 19, 2013

(51) Int. Cl. G03B 17/56

(52) U.S. Cl. CPC G03B 17/565
USPC 396/544

(57) ABSTRACT

The present invention generally relates to devices and methods for attaching light transmissive elements, such as a filter or an additional lens, to a camera lens or a camera housing. In one aspect, the present invention is directed to a pressure fit camera filter mount. The mount comprises: a light transmissive element mounted to a landing pad; a collar; an extension plate which connects the landing pad to the collar wherein the collar is capable of sliding over a camera lens or camera housing, and wherein the interior of the collar is slightly smaller than the camera lens or camera housing over which it would be slid.

### FIELD OF THE INVENTION

The present invention generally relates to devices and methods for attaching light transmissive elements, such as a filter or an additional lens, to a camera lens or a camera housing.

### BACKGROUND ON THE INVENTION

There has been research and development directed to the attachment of filters and additional lenses to a camera lens. For instance, U.S. Pat. No. 5,528,238, entitled “Camera Filter Quick Release Adapter” is allegedly directed to the following: “A camera quick release adapter has mobile thread grips in a lower unthreaded guide rim section of a ring fitting the female threads of a camera lens collar. The thread grips are operated to move inward and outward by release tabs above them in an upper section of the same ring. The two parts are attached by a backing and a circular bias spring holds them protruded outward through openings for each in the ring sections. The lower section does not have threads and slips inside the camera lens collar acting as a guide rim. For installing the adapter of this invention in the camera lens collar, the release tabs are manually depressed pushing the thread grips back from connecting with the camera lens collar threads until the lower section of the adapter seats in the base of the lens collar. The tabs are then released, the circular bias spring pushes the thread grips into the threads of the camera lens collar securing the adapter of this invention to the front of the camera lens. For quick releasing, the release tabs are pressed in pushing the thread grips away from the camera lens collar threads releasing the adapter. The ring of this adapter can be quickly removed and quickly installed along with a filter or other compatible photographic equipment attached to it.” Abstract.

Despite research and development in this area, there is still a need in the art for new devices and methods for attaching light transmissive elements to a camera lens or camera housing.

### SUMMARY OF THE INVENTION

In one aspect, the present invention is directed to a pressure fit camera filter mount. The mount comprises: a light transmissive element mounted to a landing pad; a collar; an extension plate which connects the landing pad to the collar wherein the collar is capable of sliding over a camera lens or camera housing, and wherein the interior of the collar is slightly smaller than the camera lens or camera housing over which it would be slid.

In another aspect, the present invention is directed to a method of attaching a light transmissive element to a camera lens or camera housing. The method comprises: pushing a pressure fit camera filter mount towards a camera body, wherein the mount comprises a light transmissive element mounted onto a landing pad, a collar, and an extension plate which connects the landing pad to the collar, wherein the inside of the collar is slightly smaller than the lens or housing of the camera body; contacting the pressure fit camera filter mount with the camera lens or camera housing, causing the collar to slide over the camera lens or camera housing, thereby attaching the mount to the lens or housing.

### BRIEF DESCRIPTION OF THE DRAWINGS

FIG. 1 shows a side elevational view of a pressure fit camera filter mount for a camera lens or housing in accordance with this invention. The extension plate, interior collar, and landing pad can be seen through the light transmissive element in the rear of the invention. The collar (circular embodiment) can be seen at the bottom of the front of the invention.

FIG. 2 shows the planal side view of the pressure fit camera filter mount. The landing pad can be seen connected to the extension plate. The planal side view of the collar (circular embodiment) can be seen connected to the extension plate.

FIG. 3 shows a top elevational view of the pressure fit camera filter mount. The landing pad and extension plate can be seen through the light transmissive element. (Circular collar embodiment.)

FIG. 4 shows the elevational side view of the pressure fit camera mount. The landing pad can be seen in front of the light transmissive element. The extension plate and interior collar (rectangular embodiment) can be seen through the light transmissive element in the rear of the invention.

FIG. 5 shows the elevational side view of the anterior pressure fit camera mount. The interior collar (rectangular embodiment) can be seen in the rear of the invention. The collar can be seen in the front of the invention. The landing pad can be seen connected to the extension plate in the front left and right corners of the invention.

FIG. 6 shows the planal side view of the pressure fit camera filter mount. The collar (rectangular embodiment) can be seen at the base of the invention. The landing pad can be seen at the top of the invention.

FIG. 7 shows the rear elevational view of the pressure fit camera filter mount. The extension plate can be seen on the top, left, right and bottom of the invention. The collar (rectangular embodiment) can be seen in the center of the invention connected to the extension plate. The light transmissive element can be seen through the collar.

### DETAILED DESCRIPTION OF THE INVENTION

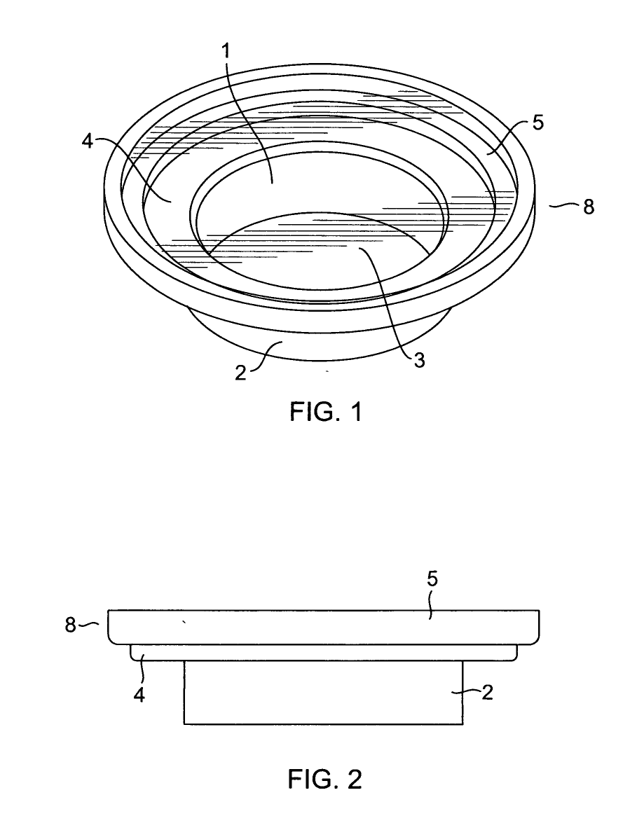

Referring now to the drawings where the numeral 8 indicates the invention and is hereafter referred to as invention 8. FIG. 1 shows the front elevational view of the invention 8. The interior collar 1, which is shown as a circular embodiment, can be seen through the light transmissive element 3, connected to the extension plate 4. The extension plate 4 can also be seen through the light transmissive element 3 connected to the landing pad 5. The collar 2 can be seen at the base of the invention 8.

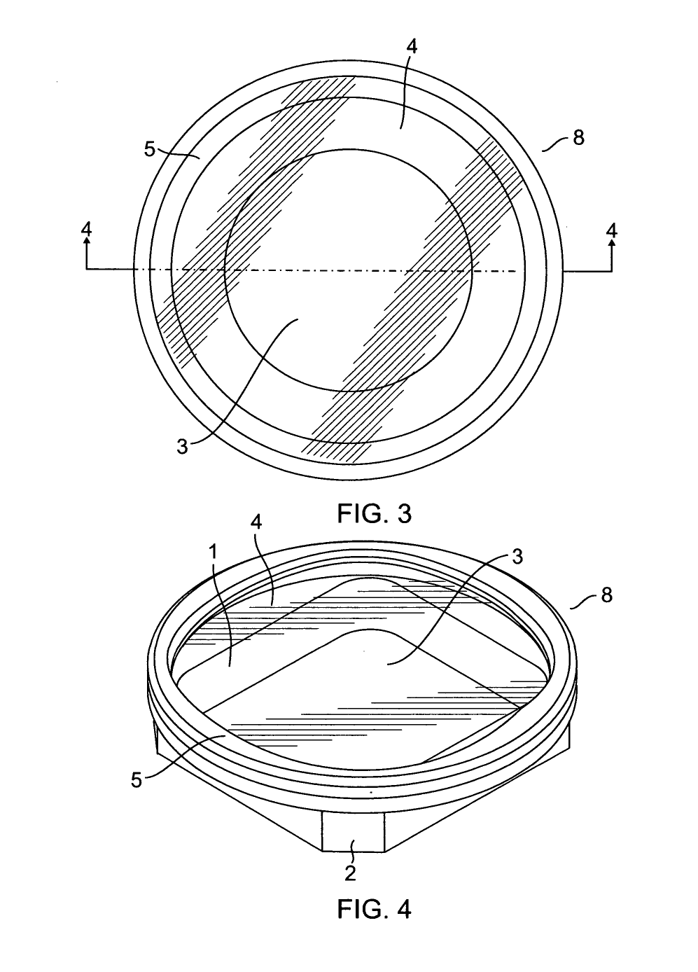

FIG. 2 shows the invention 8 in a planal side view where the collar 2, shown as a circular embodiment, can be seen at the bottom of the invention 8. The extension plate 4 can be seen connecting the landing pad 5 with the collar 2.

FIG. 3 shows the elevational view of the invention 8. Seen looking through the light transmissive element 3 are the extension plate 4 and the landing pad 5. The landing pad 5 can also be seen surrounding the outside of the light transmissive element 5.

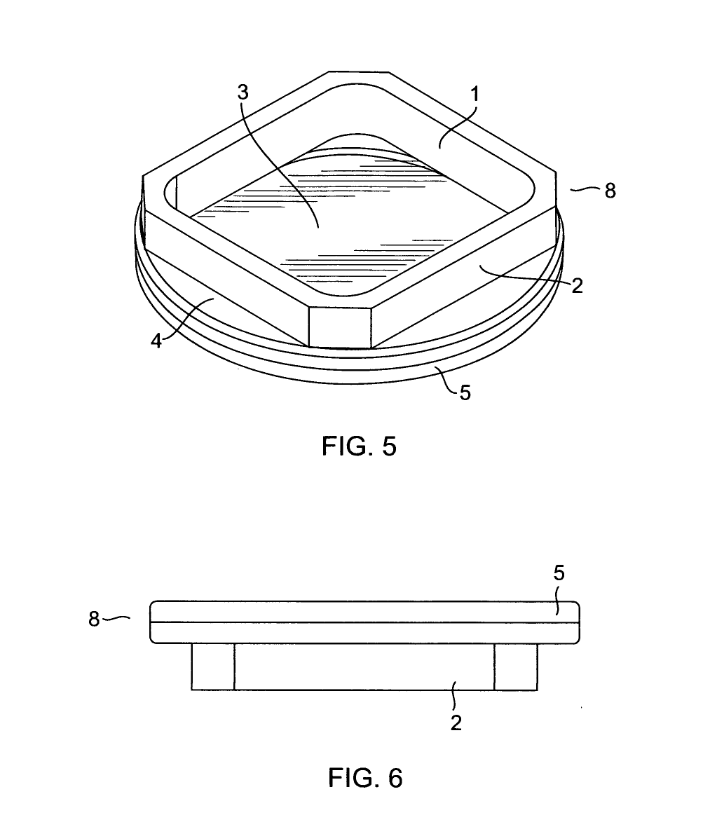

FIG. 4 illustrates an elevational side view of the invention 8. The landing pad 5 can be seen surrounding the light transmissive element 3. The collar 2, shown as a rectangular embodiment, can be seen at the base of the invention 8. Seen through the light transmissive element 3 is the extension plate 4 connecting to the interior collar.

FIG. 5 shows the rear elevational side view of the invention 8. The collar 2, shown as a rectangular embodiment, and interior collar 1 can be seen at the top of the invention 8. The extension plate 4 can be seen connecting the landing pad 5 with the collar 2. The light transmissive element 3 can be seen looking through the interior collar 1.

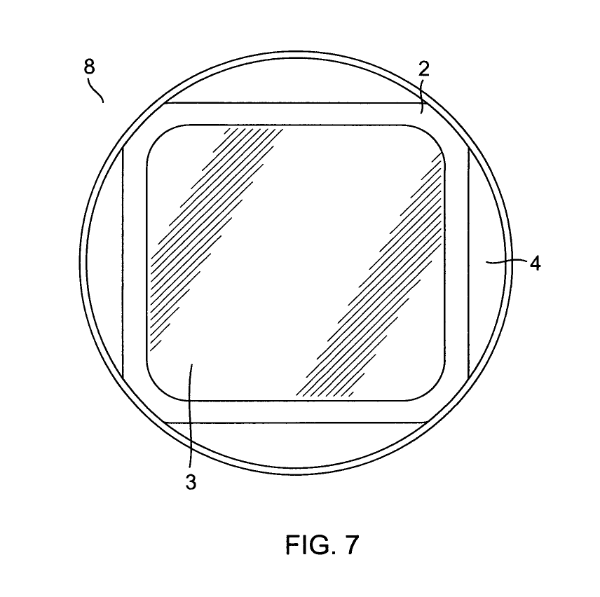

FIG. 6 shows the planal side view of the invention 8. The collar 2, shown as a rectangular embodiment, can be seen at the base of the invention 8. The landing pad 5 can be seen at the top of the invention 8.

FIG. 7 illustrates the elevational rear view of the invention 8. The extension plate 4 can be seen connected to the collar 2, shown as a rectangular embodiment, on the top, left, right, and bottom of the invention 8. The light transmissive element 3 can be seen looking through the collar 2.

### OPERATION

FIG. 1 illustrates the light transmissive element 3 mounted to the landing pad 5 of the invention 8. The structure of the landing pad 5 acts as a mounting point for the light transmissive element 3 to mount to the invention 8. The collar 2 of the invention is designed to slide over a camera lens or camera housing. The interior collar 1 is the interior surface of the collar 2. The interior collar 1 is designed to be the primary connection point between the invention 8 and a camera lens or housing. The interior collar 1 is designed to be slightly smaller than the camera lens or camera housing. The interior collar 1 utilizes friction or pressure to connect the invention 8 to a camera or camera housing.

A user will place the invention 8 over a camera lens or camera housing, pushing the invention 8 downward towards the camera body. The force of the downward pressure causes the interior collar 1 to come in contact with a camera lens or camera housing. The users downward pressure allows the invention 8 to slide over the camera lens, or camera housing. Without the user's downward pressure, the friction or pressure between the interior collar 1 and the camera lens or camera housing keep the invention 8 affixed to the camera lens or camera housing. To release the invention 8 from a camera lens or camera housing the user adds pressure to the invention 8 in an upward direction away from a camera. The upward pressure on the invention 8 allows the pressure connection between the interior collar 1 and the camera lens or camera housing to disengage allowing the invention 8 to slide off of a camera lens or camera housing.

From a reading of the foregoing, those familiar with the art should understand the assemblage and advantages of the present invention over available camera filters and lens attachment devices, whereas the available attachment devices are not compatible.

Alternative aspects of the invention include, for example, the modification of the shapes and sizes of the collar, interior collar, flexion plate, and landing pad, to accommodate different camera lenses and camera housings. The light transmissive element can be permanently affixed to the landing pad, screw into the landing pad, or could also be a removable piece allowing users to switch out lenses and filters. The light transmissive element can also vary in shape, size and proportion to the collar. The interior collar can also be modified in shape and texture to achieve different levels of pressure connection between the invention and camera lens or housing.

### DRAWING NUMBERS

1—Interior Collar
2—Collar
3—Light Transmissive Element
4—Extension Plate
5—Landing Pad
8—Invention

1. A pressure fit camera filter mount, wherein the mount comprises:
a light transmissive element mounted to a landing pad;
a collar;
an extension plate which connects the landing pad to the collar wherein the collar is capable of sliding over a camera lens or camera housing, and wherein the interior of the collar is slightly smaller than the camera lens or camera housing over which it would be slid.

2. The pressure fit camera mount according to claim 1, wherein the light transmissive element is permanently affixed to the landing pad.

3. The pressure fit camera mount according to claim 1, wherein the light transmissive element is removeable from the landing pad.

4. A method of attaching a light transmissive element to a camera lens or camera housing, wherein the method comprises:
pushing a pressure fit camera filter mount towards a camera body, wherein the mount comprises a light transmissive element mounted onto a landing pad, a collar, and an extension plate which connects the landing pad to the collar, wherein the inside of the collar is slightly smaller than the lens or housing of the camera body;
contacting the pressure fit camera filter mount with the camera lens or camera housing, causing the collar to slide over the camera lens or camera housing, thereby attaching the mount to the lens or housing.

5. The method according to claim 4, wherein the light transmissive element is permanently affixed to the landing pad.

6. The method according to claim 4, wherein the light transmissive element is removeable from the landing pad.
